(19) United States
(12) Patent Application Publication
(10) Pub. No.: US 2012/0109029 A1
(43) Pub. Date: May 3, 2012

(54) VIBRATION TRANSDUCER AND SOMATOSENSORY VIBRATION DEVICE HAVING VIBRATION TRANSDUCER

(75) Inventor: Xuejun Ma, Shenzhen (CN)

(73) Assignee: SHENZHEN BREO TECHNOLOGY CO., LTD., Shenzhen, Guangdong (CN)

(21) Appl. No.: 13/129,981

(22) PCT Filed: May 18, 2010
(86) PCT No.: PCT/CN10/72898

§ 371 Date: May 18, 2011

(51) Int. Cl. A61H 1/00; H02K 33/00

(52) U.S. Cl. 601/46; 310/16

(57) ABSTRACT

The present invention provides a vibration transducer which includes a main housing, a top cover, a supporting member, a magnetic yoke structure member, a coil frame, and a coil displaced around the coil frame. The main housing, the top cover, and the supporting member are firmly connected together, the supporting member has an elastic suspending portion, the magnetic yoke structure member is suspended on the suspending portion of the supporting member, the coil frame is fixedly attached to the main housing, and the coil frame has a junction portion made from heat insulation material, the coil frame is secured to the main housing through the junction portion, and a heat dissipating opening is defined in the main housing or the top cover.

### TECHNICAL FIELD

The present invention relates to vibration transducers, and more particularly, to a power energy-mechanical energy vibration transducer.

### BACKGROUND

Somatosensory music vibration is a sort of vibration generated by sound, or vibration transmitted via the earth. Presently, somatosensory music vibration has been used in mattresses, sofas, chairs, etc., and it can relax the human body, even can be used for alcoholic fermentation and accelerating maturity, and improving quality and so on.

Existing somatosensory music device is based on a transformation device that electrical energy is changed into mechanical vibration energy. For example, two Chinese patent applications whose publication numbers are CN 1592496A and CN 101483799A respectively disclose a transformation device used for changing electrical energy into mechanical vibration energy. However, such devices have disadvantages: an enclosure of the device is made of metal material which is easy to dissipating heat, and the part used for supporting the coil is fixed to the enclosure, the part is made of metal material with thermal conductivity, and the heat produced by the coil is passed directly through the enclosure via the part to thereby dissipating heat through the metal enclosure. The part is usually glued to the enclosure via adhesive. It requires tight bonding and does not have a gap, or else, poor thermal conductivity is produced to thereby cause complex production process and low production efficiency.

### SUMMARY

A technical problem solved by the present invention is to provide a vibration transducer which has simple production process and high production efficiency, and a somatosensory vibration device having the vibration transducer.

The above-mentioned technical problems can be solved through the following technical solutions: a vibration transducer includes a main housing, a top cover, a supporting member, a magnetic yoke structure member, a coil frame, and a coil displaced around the coil frame. The main housing, the top cover, and the supporting member are firmly connected together, the supporting member has an elastic suspending portion, the magnetic yoke structure member is suspended on the suspending portion of the supporting member, the coil frame is fixedly attached to the main housing, and the coil frame has a junction portion made from heat insulation material, the coil frame is secured to the main housing through the junction portion, and a heat dissipating opening is defined in the main housing or the top cover.

In addition, a somatosensory vibration device includes a carrier and a vibration transducer placed inside the carrier.

Preferably, a heat dissipating opening is respectively defined in the main housing and the top cover.

Preferably, the heat dissipating opening includes an opening and a plurality of cooling holes arranged in one or more circles around the opening, and a diameter of the opening is larger than that of the cooling hole.

Preferably, the main housing defines a positioning groove arranged between the opening and the cooling holes, the junction portion is securely accommodated in the positioning groove, and the opening is surrounded by the positioning groove.

Preferably, the coil frame is tubular and has a matching portion located above the junction portion, and the coil is displaced around the matching portion.

Preferably, the matching portion is made of aluminum.

Preferably, the supporting member further includes a mounting portion securely connected to the main housing and the top cover, the suspending portion includes a connecting end and a free end, the connecting end is firmly secured to the mounting portion, and the free end is used for suspendedly connecting the magnetic yoke structure member.

Preferably, the main housing defines a through hole therein.

Preferably, the magnetic yoke structure member includes a yoke iron, a magnet, a yoke piece, a sidewall of the yoke iron facing to the main housing defines a positioning slot for securing the magnet and the yoke piece therein, the magnet is clamped by the yoke iron and the yoke piece, and a ring-shaped interspace is defined between an inner sidewall of the positioning slot, an outer circumferential surface of the magnet, and an outer circumferential surface of the yoke piece.

Preferably, the coil is extended in the interspace.

Preferably, both the main housing and the top cover are made of plastic material.

Preferably, the supporting member and the magnetic yoke structure member are firmly connected via at least one first threaded fastener.

Preferably, the supporting member and the main housing is firmly connected via at least one second threaded fastener.

Preferably, a side of the supporting member, facing to the top cover, is formed to have a mounting slot for accommodating the top cover therein.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded view of a vibration transducer in accordance with an embodiment of the present invention;

FIG. 2 is a sectional view of the vibration transducer in accordance with the embodiment of the present invention;

FIG. 3 is a schematic view of a magnetic yoke structure member and a supporting member in assembly;

FIG. 4 is a sectional view taken along A-A in FIG. 3;

FIG. 5 is another schematic view of the magnetic yoke structure member and the supporting member in assembly;

FIG. 6 is an exploded view of the magnetic yoke structure member and the supporting member before assembly;

FIG. 7 is an exploded view of the magnetic yoke structure member;

FIG. 8 is a schematic view of a coil frame and a main housing in assembly;

FIG. 9 is an enlarged view of a circle denoted A in FIG. 8;

FIG. 10 is a perspective view of the main housing, the coil frame and a coil in assembly;

FIG. 11 is a schematic view of a coil frame and a main housing in assembly in accordance with another embodiment of the present invention;

FIG. 12 is an enlarged view of a circle denoted B in FIG. 11;

FIG. 13 is another schematic view of the main housing;

FIG. 14 is a further schematic view of the main housing; and

FIG. 15 is another schematic view of the main housing.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

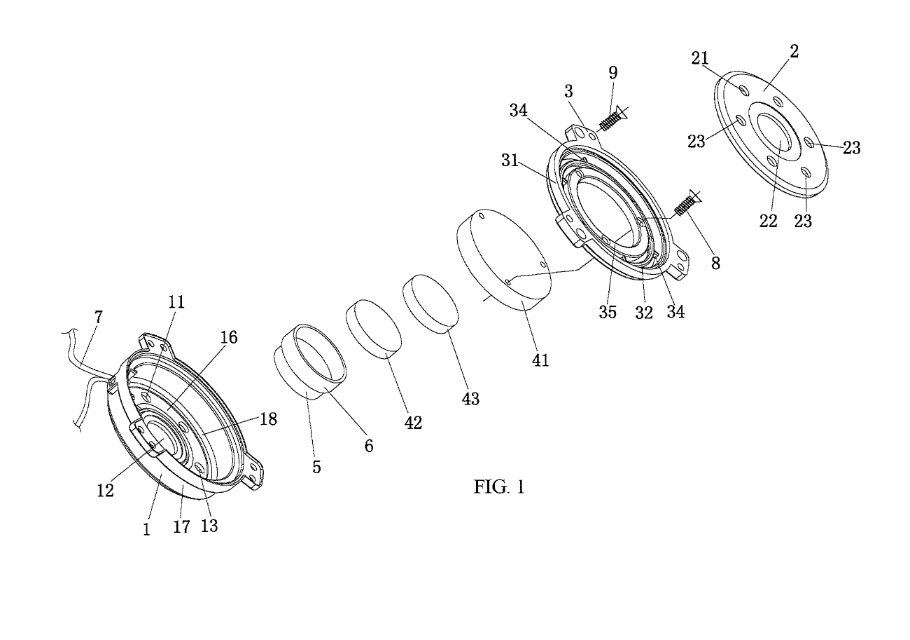

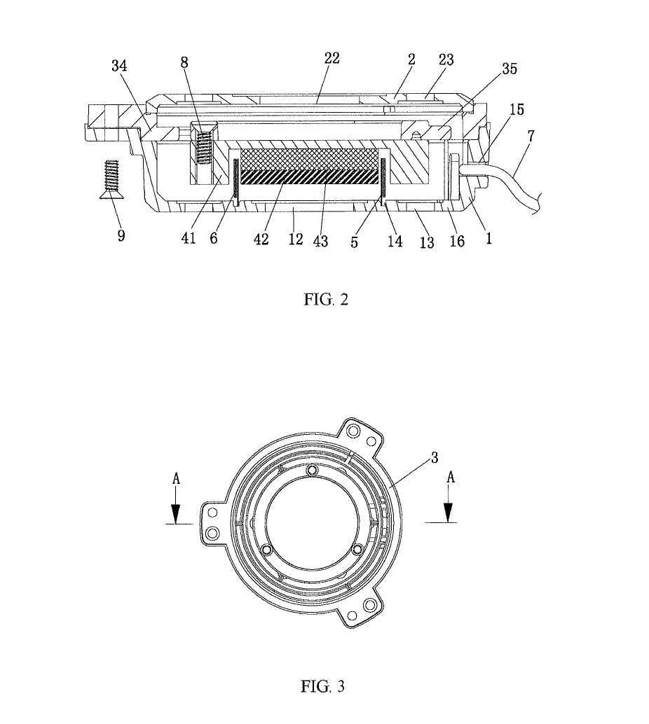

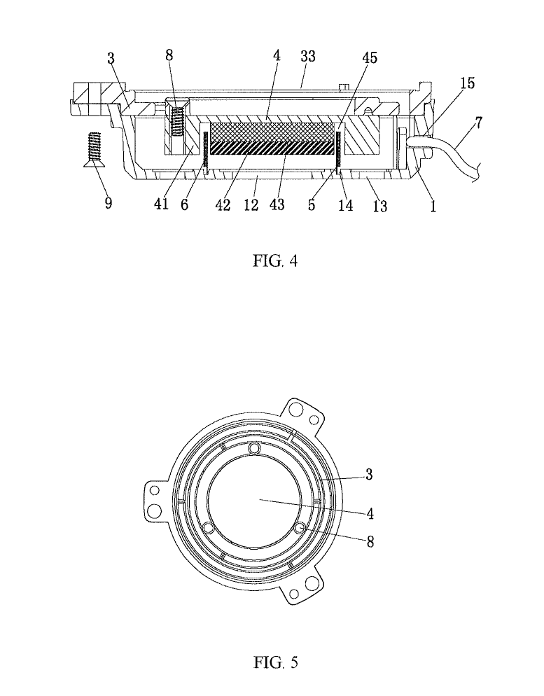

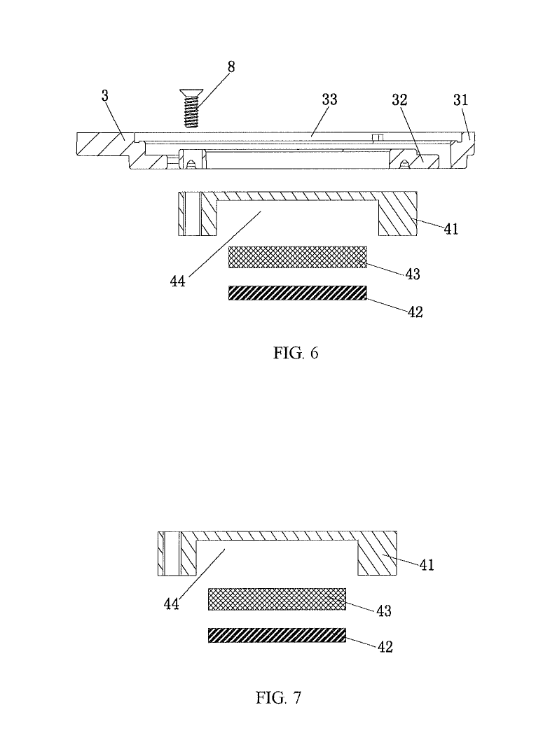

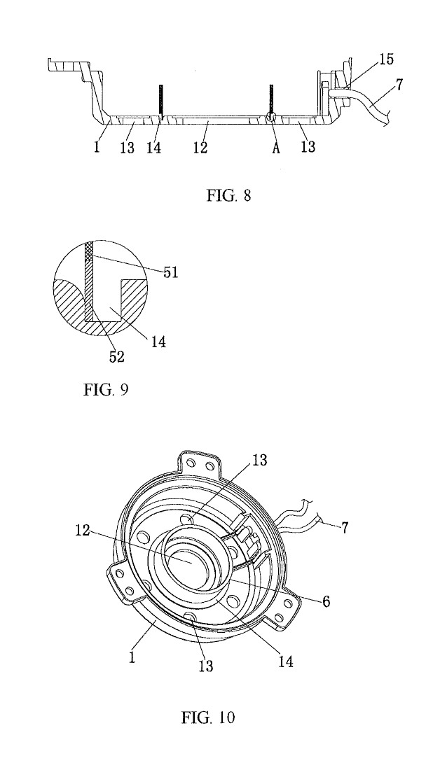

Referring to FIG. 1 to FIG. 10, the vibration transducer in accordance with an embodiment of the present invention includes a main housing 1, a top cover 2, a supporting member 3, a magnetic yoke structure member 4, a coil frame 5 and a coil 6. The main housing 1, the top cover 2, and the supporting member 3 are connected together. The magnetic yoke structure member 4 which is suspended below the supporting member 3 can vibrate up and down. The coil frame 5 is fixedly attached to the main housing 1, and the coil 6 is supported on the coil frame 5.

The main housing 1 includes a bottom portion 16 and a wall 17 extending out of the bottom portion 16. A cavity 18 is formed by the bottom portion 16 and the wall 17, and a plurality of first heat dissipating openings 11 are defined in the bottom portion 16. The first heat dissipating opening 11 includes a first opening 12 defined in a center of the bottom portion 16 and a plurality of first cooling holes 13 arranged in one or more circles around the first opening 12. A diameter of the first opening 12 is larger than that of the first cooling hole 13. A side of the bottom portion 16, facing the top cover 2, defines a ring positioning groove 14 arranged between the first opening 12 and the first cooling holes 13. And, the positioning groove 14 is displaced around the first opening 12. The wall 17 also defines a through hole 15 for the conducting wire extending therethrough.

The top cover 2 defines a plurality of second heat dissipating openings 21 therein, and the second heat dissipating opening 21 includes a second opening 22 defined in a center of the top cover 2 and a plurality of second cooling holes 23 arranged in one or more circles around the second opening 22. A diameter of the second opening 22 is larger than that of the second cooling hole 23.

The supporting member 3 includes a mounting portion 31 and a suspending portion 32. The mounting portion 31 is securely connected to the main housing 1. A side of the mounting portion 31, facing to the top cover 2, is formed to have a mounting slot 33 therein. The elastic suspending portion 32 has a connecting end 34 and a free end 35. The connecting end 34 is firmly secured to the mounting portion 31. The number of the connecting end 34 may be one or more than one, and the free end 35 may be deformed when the free end 35 is exerted by outer force. The number of the free end 35 may be one or more than one. For example, the free end 35 may be circular, quadrate or polygonal. The suspending portion 32 may be more than one, and each suspending portion 32, such as a spring, has the free end 35 for suspendedly connecting the magnetic yoke structure member 4 and the connecting end 34 for firmly connecting with the mounting portion 31.

The magnetic yoke structure member 4 includes a yoke iron 41 which can produce a closed magnetic flux, a yoke piece 42, and a magnet 43. A sidewall of the yoke iron 41, facing to the main housing 1, defines a positioning slot 44 for securing the magnet 43 therein. Both the magnet 43 and the yoke piece 42 are mounted in the positioning slot 44. The magnet 43 is clamped by the yoke iron 41 and the yoke piece 42. The magnet 43 is securely positioned to a bottom portion of the positioning slot 44. And, a ring-shaped interspace 45 is defined between an inner sidewall of the positioning slot 44, an outer circumferential surface of the magnet 43, and an outer circumferential surface of the yoke piece 42.

The coil frame 5 is a tubular body in shape, and its cross section is, for example, circular, rectangular, or polygonal and other shape. The coil frame 5 has a matching portion 51 and a junction portion 52 located below the matching portion 51. The junction portion 52 is made from heat insulation material, such as the non-metallic material or other material producing heat insulation effect. The matching portion 51 is made from thermal conductivity material, such as aluminum and other metal material, or other material producing thermal effect. The junction portion 52 is used for fixedly connecting with the main housing 1. The matching portion 51 is used for matching with the coil 6. The coil 6 is coupled to a conducting wire 7 which is used to provide an electric signal to the coil 6.

The main housing 1 and the top cover 2 may be made from the plastic material which is resistant to high temperature. The junction portion 52 of the coil frame 5 can be made from heat insulation material which are resistant to high temperature. When the coil 6 is heated by switching on power, the heat will be partially transferred to the main housing 1, the top cover 2, and the junction portion 52 of the coil frame 5. The main housing 1, the top cover 2, and the coil frame 5 may be uneasy to be damaged in high temperature due to heat insulation material which are resistant to high temperature.

In assembly of vibration transducer, an upper end surface of the magnet 43 is secured to a bottom portion of the positioning slot 44 to thereby secure the yoke piece 42 to a lower end surface of the magnet 43, and to thereby form the magnetic yoke structure member 4. The yoke iron 41 and the suspending portion 32 of the supporting member 3 are locked by a first threaded fastener 8 to thereby make the magnetic yoke structure member 4 being suspended below the supporting member 3. Then, the junction portion 52 of the coil frame 5 is positioned in the positioning groove 14 of the main housing 1. The coil 6 is disposed around the matching portion 52 of the coil frame 5. The conducting wire 7 connecting the coil 6 extends through the through hole 15 of the main housing 1. The main housing 1 and the mounting portion 31 of supporting member 3 are locked by a second threaded fastener to thereby firmly connect the main housing 1 with the supporting member 3. Finally, the top cover 2 is embedded in the mounting slot 33 of the supporting member 3. After assembly, the magnetic yoke structure member 4 and the supporting member 3 are located between the top cover 2 and the main housing 1, the magnetic yoke structure member 4 is accommodated in a cavity of the main housing 1, and the coil 6 is extended in the ring-shaped interspace 45 of the magnetic yoke structure member 4.

In use of the vibration transducer, the coil 6 is provided with the electric signal via the conducting wire 7, and the coil 6 cuts the magnetic line of the coil 6. Because the magnetic yoke structure member 4 is suspended on the deformable suspending portion 32 of the supporting member 3, to thereby cause to change the relative position between the magnetic yoke structure member 4 and the main housing 1. Therefore, the magnetic yoke structure member 4 is vibrated up and down in an axial direction of the main housing 1, thereby creating a sense of vibration of the human body.

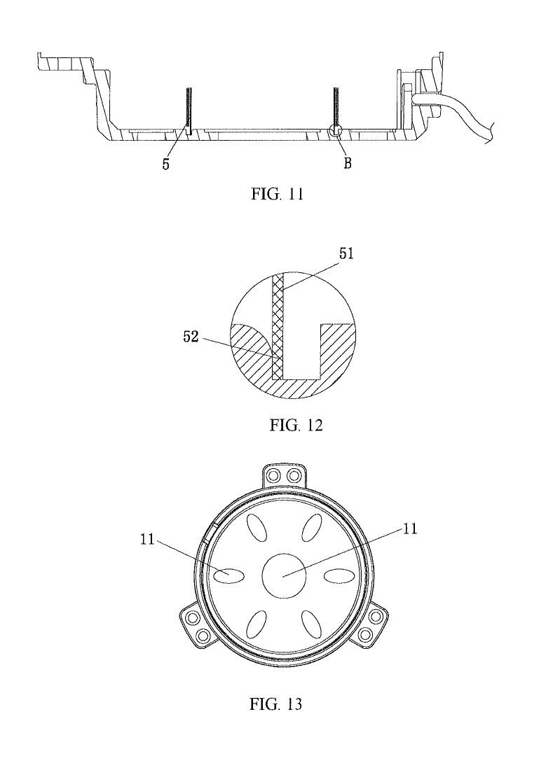

The second embodiment of the coil frame is shown in FIGS. 11 and 12. The free portion 51 and the junction portion 52 of the coil frame 5 are made from heat insulation material.

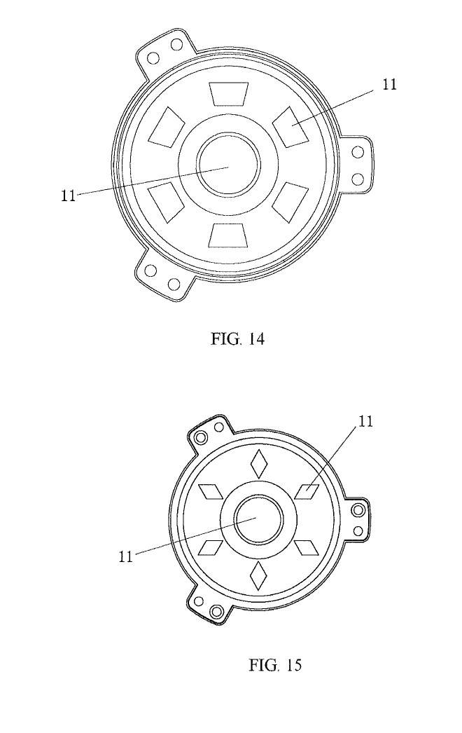

The shape, size, number and distribution of the first heat dissipating opening of the main housing 1 can be designed according to requirement, as shown in FIGS. 13, 14 and 15.

The vibration transducer includes a main housing, a top cover, a magnetic yoke structure member, a coil frame and a coil. The main housing, the top cover, and the magnetic yoke structure member are firmly connected together. The magnetic yoke structure member is suspended below the supporting member. The coil is supported on the coil frame, and the coil frame has a junction portion made from heat insulation material. The junction portion is secured to the main housing. And, the main housing or the top cover defines an opening for dissipating heat therein, or both the main housing and the top cover define an opening for dissipating heat therein. By setting the junction portion with heat insulation, the heat given off from the coil can be avoided or reduced to directly transfer to the main housing, thereby causing the main housing to directly dissipate heat. In the embodiment, much heat is dissipated through the opening because of airflow, thereby obtaining high thermal transmission efficiency. While, much more heat is dissipated via the opening so that less heat is transferred to the magnetic yoke structure member, therefore, the magnetic yoke structure member is not easy to overheat. When both the main housing and the top cover are equipped with cooling openings, the air inside the vibration transducer is more conducive to flow to thereby more easily dissipate heat. The shape, size, number and distribution of the heat dissipating openings of the main housing and the top cover can be designed according to requirement.

In order to facilitate positioning the coil frame, a positioning slot may be defined in the main housing. As much heat produced by the coil is dissipated through airflow, rather than being transferred to the main housing through the coil frame. Thus, the assembly requirement of the coil frame and the main housing is reduced, and it is easy to manufacture on production lines.

In order to facilitate assembly of the vibration transducer, a through hole may be defined in the main housing. Thus, a conducting wire connected with the coil is not needed to pass through a junction portion between the main housing and the top cover. In assembly, the conducting wire and the coil are beforehand installed before the top cover is mounted, thereby simplifying the assembly process. Simultaneously, when opening the top cover, the conducting wire is not moved to thereby facilitate maintenance.

In order to avoid vibration frequency and high temperature influencing the junction between the magnetic yoke structure member and the supporting member, the magnetic yoke structure member and the supporting member can be firmly connected via at least one threaded fastener.

The heat produced by the main body may be dissipated through airflow, therefore, the main housing and the top cover can be made of plastic material, thereby reducing manufacturing costs.

For the vibration transducer, the main housing and the top cover constitute an enclosure, and the magnetic yoke structure member, the supporting member, the coil frame and the coil are located in the enclosure. The main housing and the top cover may be the aforementioned structure, or existing structure, or other structure used for placing the magnetic yoke structure member, the coil and the coil frame therein. The magnetic yoke structure member may be the aforementioned structure, or existing structure, or other structure which has a magnet and the magnetic line of the magnet can be cut by the coil. The supporting member may be the above-mentioned structure, or the existing structure, or other structure which the magnetic yoke structure member is hung and connected thereon and when the coil is switched on power to cause the magnetic yoke structure member to be vibrated up and down. The whole coil frame can be made from heat insulation material, or a portion of the coil frame connected with the main housing is only made from heat insulation material.

A somatosensory vibration device includes a carrier and a vibration transducer, and the vibration transducer placed inside the carrier. The somatosensory vibration devices may be a head massager having a vibration transducer, an eye massager, a massage chair, a massage cushion, a massage sofa, and so on.

The advantages of the present invention are: by setting the junction portion with heat insulation, the heat given off from the coil can be avoided or reduced to directly transfer to the main housing, thereby causing the main housing to directly dissipate heat. Much heat is dissipated through the opening because of airflow, thereby obtaining high thermal transmission efficiency. In addition, as much heat from the coil is dissipated through airflow, rather than being transferred to the main housing through the coil frame. Thus, the assembly requirement of the coil frame and the main housing is reduced, the production efficiency is increased, and it is easy to produce on production lines.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A vibration transducer comprising:
a main housing, a top cover, a supporting member, a magnetic yoke structure member, a coil frame, and a coil displaced around the coil frame; wherein the main housing, the top cover, and the supporting member are firmly connected together, the supporting member has an elastic suspending portion, the magnetic yoke structure member suspended on the suspending portion of the supporting member, the coil frame is fixedly attached to the main housing, and wherein the coil frame has a junction portion made from heat insulation material, the coil frame is secured to the main housing through the junction portion, and a heat dissipating opening is defined in the main housing or the top cover.

2. The vibration transducer as claimed in claim 1, wherein a heat dissipating opening is respectively defined in the main housing and the top cover.

3. The vibration transducer as claimed in claim 2, wherein the heat dissipating opening comprises an opening and a plurality of cooling holes arranged in one or more circles around the opening, and a diameter of the opening is larger than that of the cooling hole.

4. The vibration transducer as claimed in claim 3, wherein the main housing defines a positioning groove arranged between the opening and the cooling holes, the junction portion is securely accommodated in the positioning groove, and the opening is surrounded by the positioning groove.

5. The vibration transducer as claimed in claim 4, wherein the coil frame is tubular and has a matching portion located above the junction portion, and the coil is displaced around the matching portion.

6. The vibration transducer as claimed in claim 5, wherein the matching portion is made of aluminum.

7. The vibration transducer as claimed in claim 6, wherein the supporting member further comprises a mounting portion securely connected to the main housing and the top cover, the suspending portion comprises a connecting end and a free end, the connecting end is firmly secured to the mounting portion, and the free end is used for suspendedly connecting the magnetic yoke structure member.

8. The vibration transducer as claimed in claim 1, wherein the main housing defines a through hole therein.

9. The vibration transducer as claimed in claim 1, wherein the magnetic yoke structure member comprises a yoke iron, a magnet, a yoke piece, a sidewall of the yoke iron facing to the main housing defines a positioning slot for securing the magnet and the yoke piece therein, the magnet is clamped by the yoke iron and the yoke piece, and a ring-shaped interspace is defined between an inner sidewall of the positioning slot, an outer circumferential surface of the magnet, and an outer circumferential surface of the yoke piece.

10. The vibration transducer as claimed in claim 9, wherein the coil is extended in the interspace.

11. The vibration transducer as claimed in claim 1, wherein both the main housing and the top cover are made of plastic material.

12. The vibration transducer as claimed in claim 11, wherein the supporting member and the magnetic yoke structure member are firmly connected via at least one first threaded fastener.

13. The vibration transducer as claimed in claim 12, wherein the supporting member and the main housing are firmly connected via at least one second threaded fastener.

14. The vibration transducer as claimed in claim 13, wherein a side of the supporting member, facing to the top cover, is formed to have a mounting slot for accommodating the top cover therein.

15. A somatosensory vibration device comprising:
a carrier; and
a vibration transducer placed inside the carrier,
wherein the vibration transducer comprising:
a main housing, a top cover, a supporting member, a magnetic yoke structure member, a coil frame, and a coil displaced around the coil frame; wherein the main housing, the top cover, and the supporting member are firmly connected together, the supporting member has an elastic suspending portion, the magnetic yoke structure member suspended on the suspending portion of the supporting member, the coil frame is fixedly attached to the main housing, and wherein the coil frame has a junction portion made from heat insulation material, the coil frame is secured to the main housing through the junction portion, and a heat dissipating opening is defined in the main housing or the top cover.
